(19) United States
(12) Patent Application Publication
(10) Pub. No.: US 2010/0034183 A1
(43) Pub. Date: Feb. 11, 2010

(54) Flexible WLAN/WPAN system with high throughput

(75) Inventors: Saishankar Nandagopalan, San Diego, CA (US); Christopher J. Hansen, Sunnyvale, CA (US); Vinko Erceg, Cardiff by the Sea, CA (US)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/533,900

(22) Filed: Jul. 31, 2009

Related U.S. Application Data
(60) Provisional application No. 61/086,465, filed on Aug. 5, 2008.

(51) Int. Cl. H04W 88/12; H04L 12/413; H04L 27/28

(52) U.S. Cl. 370/338; 370/445; 375/260

(57) ABSTRACT

Flexible WLAN/WPAN system with high throughput. A medium access controller (MAC), that is capable to be implemented within a communication device, is operative in accordance with any one of a number of capability sets, based on which capability set is enabled when implemented within a particular communication device. Each respective capability set directs operation of the MAC in accordance with a corresponding set of operational parameters. The enabling of one of the capability sets may be based upon one or more of a type of physical layer transceiver (PHY) with which the MAC interfaces (e.g., within the communication device), a communication protocol by which the apparatus communicates with a communication network, and/or other considerations. The MAC can include an optimization module therein that is operative to adjust one or more operational parameters based on a change of an operational condition of the communication network with which the communication device communicates.

### CROSS REFERENCE TO RELATED PATENTS/PATENT APPLICATIONS

### Provisional Priority Claims

The present U.S. Utility Patent Application claims priority pursuant to 35 U.S.C. § 119(e) to the following U.S. Provisional Patent Application which is hereby incorporated herein by reference in its entirety and made part of the present U.S. Utility Patent Application for all purposes:

1. U.S. Provisional Application Ser. No. 61/086,465, entitled “Flexible WLAN/WPAN system with high throughput,” (Attorney Docket No. BP7378), filed Aug. 5, 2008, pending.

### BACKGROUND OF THE INVENTION

1. Technical Field of the Invention

The invention relates generally to communication systems; and, more particularly, it relates to medium access controllers (MACs) as employed within such communication systems.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, etc. communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to an antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

While transmitters generally include a data modulation stage, one or more IF stages, and a power amplifier, the particular implementation of these elements is dependent upon the data modulation scheme of the standard being supported by the transceiver. For example, if the baseband modulation scheme is Gaussian Minimum Shift Keying (GMSK), the data modulation stage functions to convert digital words into quadrature modulation symbols, which have a constant amplitude and varying phases. The IF stage includes a phase locked loop (PLL) that generates an oscillation at a desired RF frequency, which is modulated based on the varying phases produced by the data modulation stage. The phase modulated RF signal is then amplified by the power amplifier in accordance with a transmit power level setting to produce a phase modulated RF signal.

As another example, if the data modulation scheme is 8-PSK (phase shift keying), the data modulation stage functions to convert digital words into symbols having varying amplitudes and varying phases. The IF stage includes a phase locked loop (PLL) that generates an oscillation at a desired RF frequency, which is modulated based on the varying phases produced by the data modulation stage. The phase modulated RF signal is then amplified by the power amplifier in accordance with the varying amplitudes to produce a phase and amplitude modulated RF signal.

As yet another example, if the data modulation scheme is x-QAM (16, 64, 128, 256 quadrature amplitude modulation), the data modulation stage functions to convert digital words into Cartesian coordinate symbols (e.g., having an in-phase signal component and a quadrature signal component). The IF stage includes mixers that mix the in-phase signal component with an in-phase local oscillation and mix the quadrature signal component with a quadrature local oscillation to produce two mixed signals. The mixed signals are summed together and filtered to produce an RF signal that is subsequently amplified by a power amplifier.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a diagram illustrating an embodiment of multiple operating wireless networks with overlapping coverage.

FIG. 2 is a diagram illustrating an embodiment of a piconet controller (PNC) beaconing superframes to various communication devices.

FIG. 3A is a diagram illustrating an embodiment of a superframe that includes a contention access period and a polled access period.

FIG. 3B is a diagram illustrating an embodiment of a superframe that includes a contention access extending during a majority of the superframe's.

FIG. 4 is a diagram illustrating an embodiment of a medium access controller (MAC) having multiple capabilities and possible implementations including interfacing with various types of physical layer transceivers (PHYs).

FIG. 5 is a diagram illustrating an embodiment showing multiple capabilities of a MAC core.

FIG. 6 is a diagram illustrating an embodiment of a method for configuring a communication device.

### DETAILED DESCRIPTION OF THE INVENTION

Communication systems have been around for some time, and their presence into modern life is virtually ubiquitous (e.g., television communication systems, telecommunication systems including wired and wireless communication systems, etc.). As these communication systems continue to be developed, there is an ever present need for designing various means by which information may be encoded for transmitting from a first location to a second location.

Generally speaking, the goal of digital communications systems is to transmit digital data from one location, or subsystem, to another either error free or with an acceptably low error rate. Data may be transmitted over a variety of communications channels in a wide variety of communication systems: magnetic media, wired, wireless, fiber, copper, and other types of media as well.

There are a variety of types of communication system types and communication device types that may be implemented within such communication systems. There are a variety of communication protocols by which communications within such communication systems may be supported including the IEEE 802.15.3, IEEE 802.11 a/b/g/n, and others.

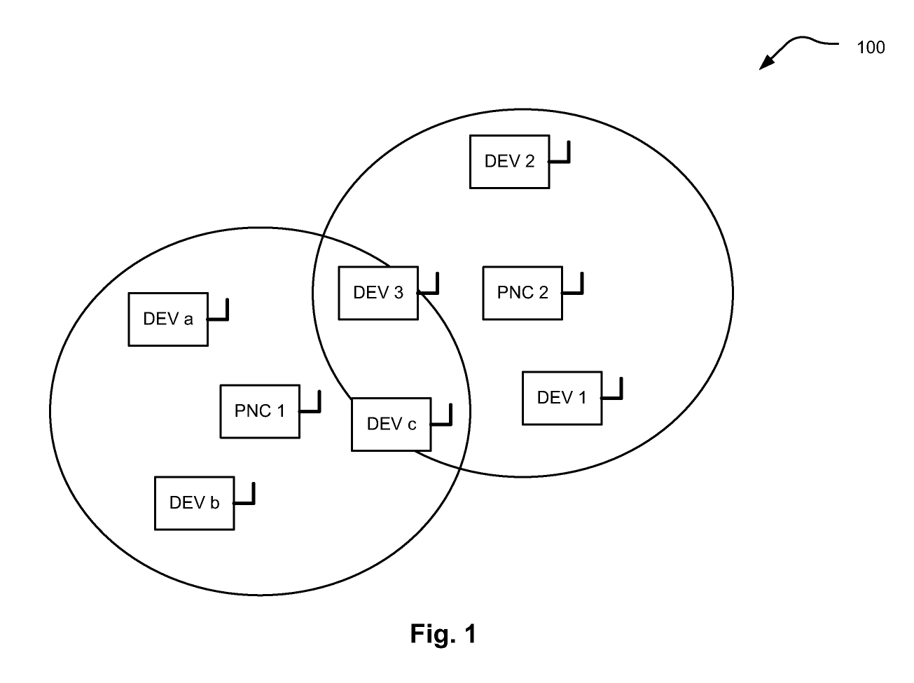

FIG. 1 is a diagram illustrating an embodiment 100 of multiple operating wireless networks with overlapping coverage.

Within the wireless communication system context, one issue of concern can be when multiple operating wireless networks (e.g., piconets and/or personal area networks (PANs), wireless local area networks (WLANs), and/or other wireless communication network types). In this embodiment, two communication networks have overlapping coverage areas.

A first piconet controller (PNC 1) has a first coverage area in which a number of communication devices are located (e.g., shown as DEV a, DEV b, DEV c, DEV 3). A second piconet controller (PNC 2) has a second coverage area in which other communication devices are located (e.g., shown as DEV 1, DEV 2, DEV c, DEV 3). The types of communication device that may be employed within such a communication system may be varied and can include any types of communication devices that support wireless communications (e.g., Bluetooth capable devices, cell phones, PDAs, computers (including portable/laptop type computers), etc.).

As can be seen, at least two of the communication devices (i.e., DEV c, DEV 3) are located in the overlapping coverage are of the two wireless networks. With overlapping coverage areas, there may be collisions of communications transmitted by each of the PNC 1 and PNC 2 (e.g., there are two separate PNCs operating in a common area). There are different manners of arbitration that may be employed to determine which of the communication devices, when they assert competing requests for the communication medium (e.g., access to the communication network), actually gets access to the communication network.

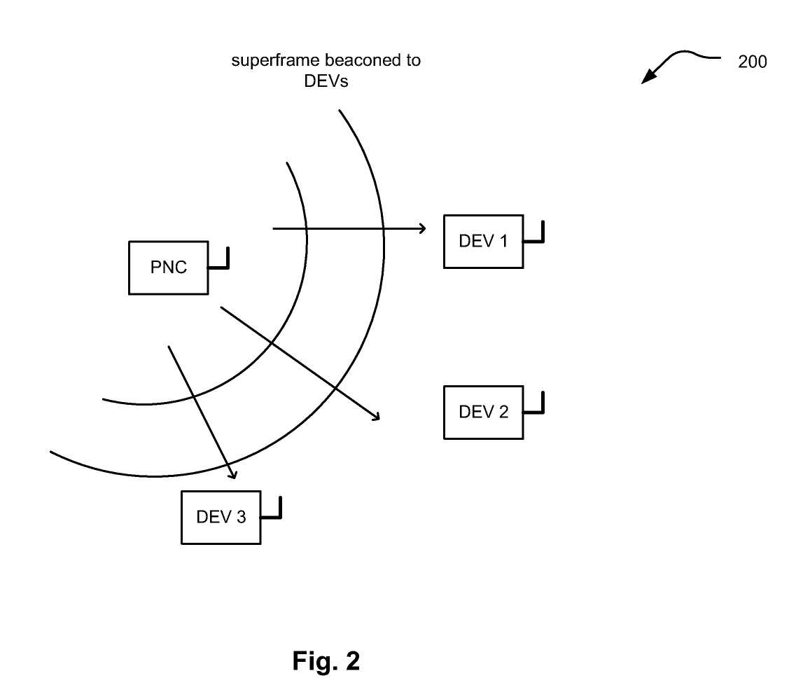

FIG. 2 is a diagram illustrating an embodiment 200 of a piconet controller (PNC) beaconing superframes to various communication devices. By a PNC beaconing superframes to these various communication devices, the structure of the superframes may indicate the manner by which access to the communication medium is performed when there are multiple communication devices being serviced by the PNC.

As can be seen in this diagram, a superframe is beaconed to the various communication devices (e.g., shown as DEV 1, DEV 2, DEV 3). Over time, different types of superframes may be beaconed to the communication devices, so that the manner by which multiple access to the communication medium (e.g., by the communication devices) changes over time. For example, during a first period of time, carrier sense multiple access/collision avoidance (CSMA/CA) may be the manner by which competing requests to access the communication medium are arbitrated. During a second period of time, polled access (e.g., during separate/partitioned time periods) may be the manner by which various communication devices are provided access to the communication medium.

In some embodiments, the CSMA/CS may govern access to the communication medium during a first portion of superframe's time period, and polled access may govern access to the communication medium during a second portion of superframe's time period. In another embodiment, during the entire period of a superframe, CSMA/CS may govern access to the communication medium. In addition, the manner by which multiple access to a communication device is performed may change over time (e.g., CSMA/CS during time period 1, polled access during time period 2, etc.).

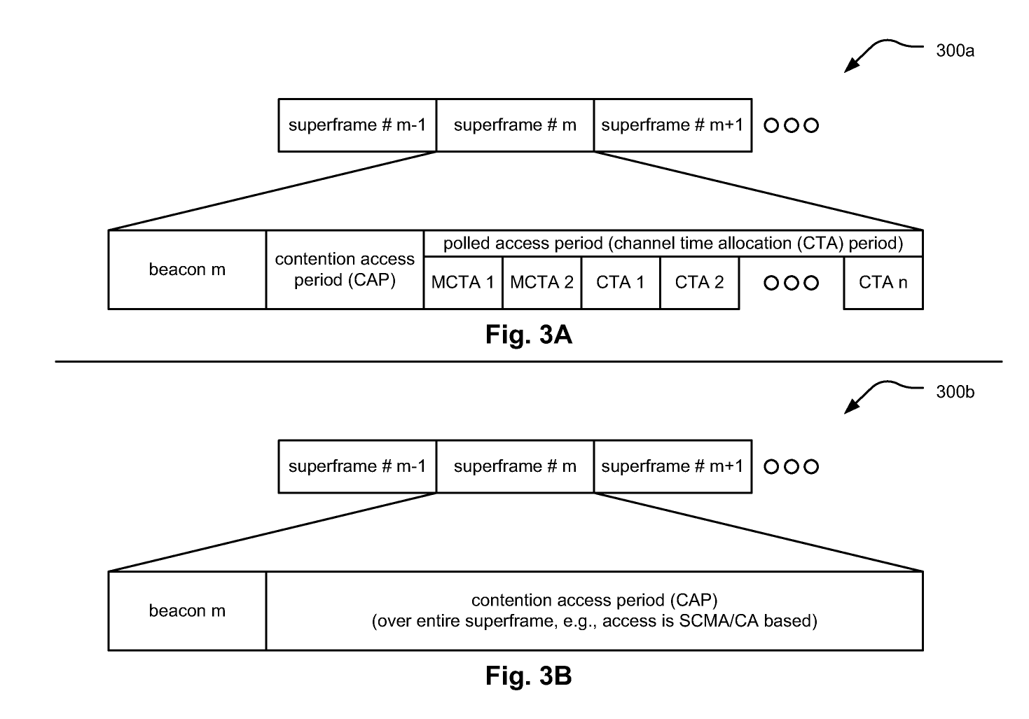

FIG. 3A is a diagram illustrating an embodiment 300a of a superframe that includes a contention access period and a polled access period. After a beacon indication field, this superframe structure includes both a contention access period (CAP) and a polled access period (i.e., a channel time allocation (CTA) period).

The CAP may be used for network initiation by a master controller communication device (e.g., a PNC in a piconet application context or an access point (AP) in a WLAN application context such as one that is compliant with 802.11). This may be viewed as a random access period in which the various communication devices within the communication network may try to access the communication medium. Generally speaking, all of the communication devices have equal priority to try to access the communication medium during the CAP. When competing requests are made, some means of arbitration is performed to try to avoid conflicts and collisions of communications between the communication devices and the master controller. There is typically some means by which prioritization may be performed among all of the communication devices. In addition, when competing requests are made to access the communication medium, then certain rules govern the backing off of the various communication devices until one of them has priority and accesses the communication medium, then another of them has priority and accesses the communication medium, etc.

In the case of asynchronous data transfer within the communication network, there generally is no scope of prioritization and each frame is followed by backoff. This manner of operation may not be optimal in the case of transmitting low latency frames.

In accordance with the polled access period, each of the communication devices (or a subset of all of the communication devices) has guaranteed channel time allocation (CTA) within one or more of the CTA periods.

Within a piconet application context, data can be transferred to a PNC or to another peer (e.g., another communication device) within the communication network. This manner of operation may be viewed as being a hybrid between a pure ad hoc and an infrastructure type communication network.

FIG. 3B is a diagram illustrating an embodiment 300b of a superframe that includes a contention access extending during a majority of the superframe's. After a beacon indication field, this superframe structure includes a contention access period (CAP) that spans the remainder of the superframe.

This superframe structure ensures that during the entire superframe period (or during a majority of the superframe period, at least during the non-beacon period), each of the communication devices within the communication network have the opportunity to try to access communication medium.

As mentioned above, and as can be seen with reference to FIG. 1, coexistence of multiple wireless communication networks within relatively close proximity (e.g., having at least some overlapping coverage area) can be problematic. When operating in accordance with the superframe structure of FIG. 3A, most of the data transmission happens during the polled access period (i.e., during the various CTAs) that was granted by a PNC (e.g., in a piconet context) or an AP (e.g., in a WLAN context).

In the case of overlapping piconets, the overall performance of the various overlapping wireless communication networks degrades. This reduction in performance can be mitigated when one or more of the PNCs of the overlapping piconets negotiate and follow some rules to form a child piconet or neighbor piconet. However, these means generally follow some form of time division multiple access (TDMA) based protocol, and this can be quite complicated in implementation. Moreover, this means of arbitration can undesirably consume much of the available bandwidth if the main piconet or wireless communication network.

The superframe structure of FIG. 3B allows the CAP to extend over the entire superframe (except for the bacon period, of course). The manner of arbitration between requests by competing communication devices to access the communication medium can be governed in accordance with CSMA/CS during the superframe. Again, it is noted that the superframe structure of FIG. 3A does in fact includes a CAP (which may be governed in accordance with CSMA/CS), but the CAP of the superframe of FIG. 3A is typically employed just for signaling information to the communication devices to reserve the CTAs (i.e., for the polled access period) and only seldom otherwise to send some asynchronous data.

The communication of asynchronous data is problematic in accordance with the superframe structure of FIG. 3A, in that, each frame (e.g., medium access controller (MAC) frame) needs to be sandwiched between backoffs. This will result in a degradation of performance of the communication system and the protocol that governs communications therein.

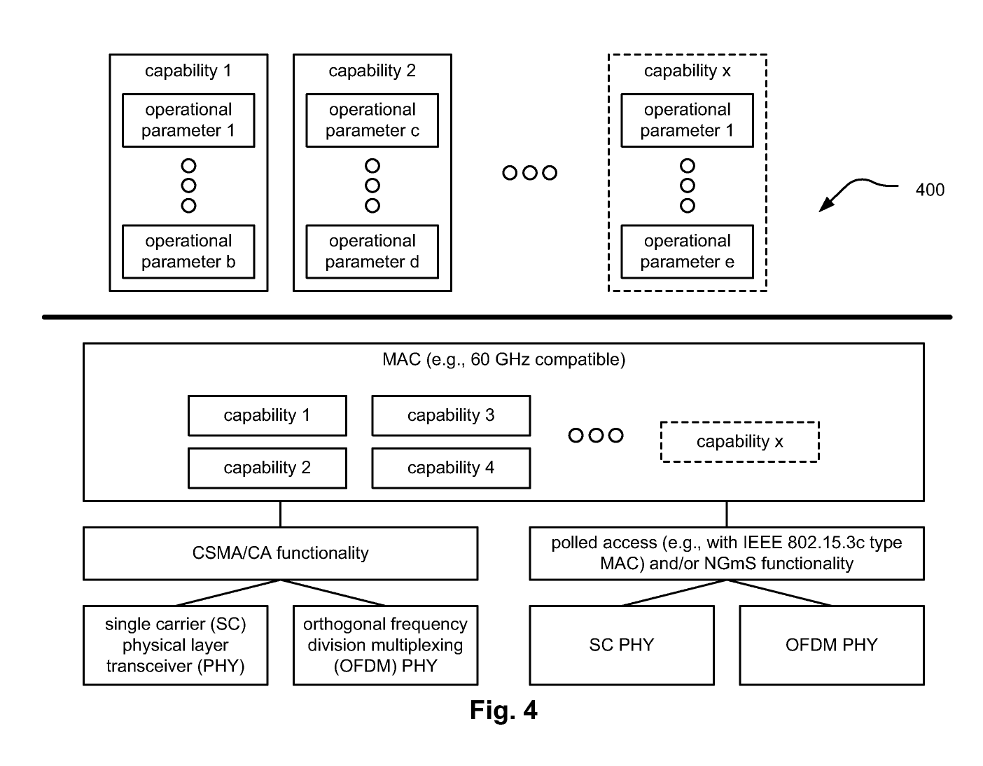

FIG. 4 is a diagram illustrating an embodiment 400 of a medium access controller (MAC) having multiple capabilities and possible implementations including interfacing with various types of physical layer transceivers (PHYs). A MAC, which may be implemented within a communication device, includes a number of different capabilities. Depending on the particular communication device in which the MAC is implemented, one or more of the capabilities of the MAC is enabled and used. In addition, depending on the particular communication protocol (protocols) by which the communication device will operate when emplaced within a communication network, one or more of the capabilities of the MAC is enabled and used.

Generally speaking, the MAC (which may be compatible with 60 GHz applications) includes a plurality of capabilities (e.g., shown as capability 1, capability 2, capability 3, capability 4, . . . , and/or capability x).

The MAC includes capabilities to allow its implementation in at least 4 different configurations. In one configuration, a first one or first group of capabilities is enabled when the MAC is implemented in a communication network in which arbitration is performed in accordance with CSMA/CS, then the MAC is enabled to interface and operate with a single carrier (SC) physical layer transceiver (PHY). In another configuration, a second one or second group of capabilities is enabled when the MAC is implemented in a communication network in which arbitration is performed in accordance with CSMA/CS, then the MAC is enabled to interface and operate with an orthogonal frequency division multiplexing (OFDM) type PHY.

Alternatively, in even a third configuration, a third one or third group of capabilities is enabled when the MAC is implemented in a communication network in which arbitration is performed in accordance with polled access (e.g., such as that in accordance with NGmS (Next Generation millimeter wave Specification)), then the MAC is enabled to interface and operate with a SC PHY. In even a fourth configuration, a fourth one or fourth group of capabilities is enabled when the MAC is implemented in a communication network in which arbitration is performed in accordance with polled access, then the MAC is enabled to interface and operate with an OFDM PHY.

When comparing the left hand side configurations (i.e., that employ CSMA/CS functionality) to the right hand side configurations (i.e., that employ polled access functionality), the left had side may be viewed as having relatively fewer features and relatively reduced complexity allowing those configurations to be implemented relatively easier and with less cost. The right hand side configurations may be viewed as having relatively more features and relatively increased complexity which may require those configurations to be implemented with some additional design and increased cost.

By employing a common MAC core as described herein, it allows the availability to implement this single MAC across a wide variety of applications, and this may be implemented very quickly thereby ensuring a relatively quick transition to market (i.e., it is fast to implement for new and changing communication system types, and it is adaptable for both SC and OFDM type PHYs).

In one embodiment, the use of CSMA/CS with respect across an entirety (or majority) of a superframe provides a means to avoid collision of communications between various communication devices and/or the PNC (e.g., in a piconet context). This may be viewed as extending the CAP of an IEEE 802.15 superframe to cover the entirety (or majority) of a superframe.

From certain perspectives, this MAC includes some of the functionality and capabilities as included within an IEEE 802.11 compliant MAC core.

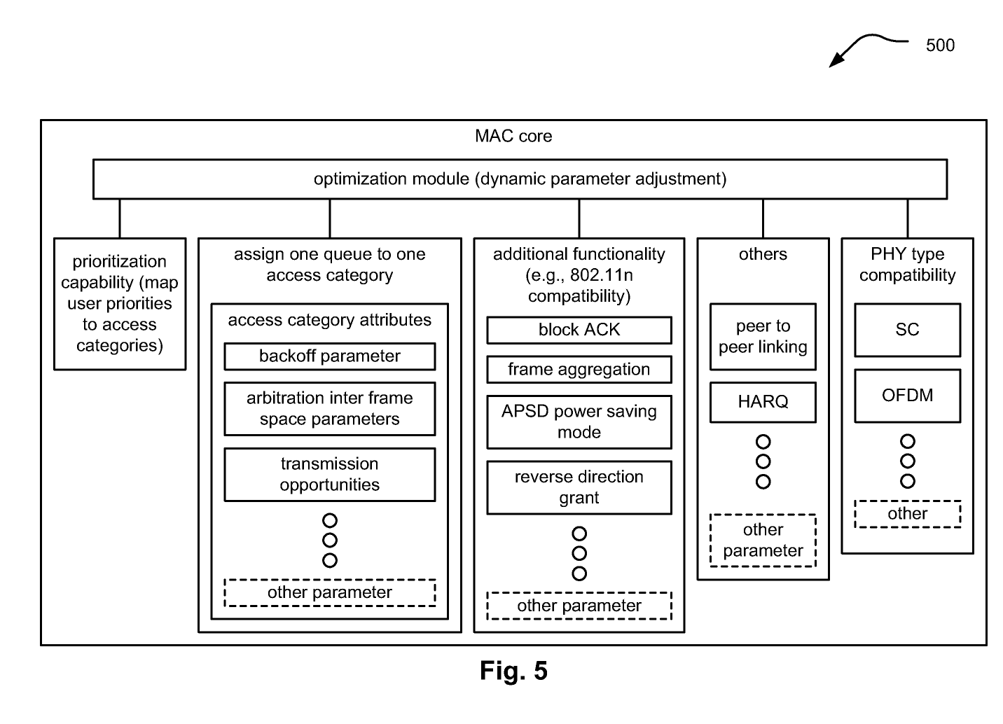

FIG. 5 is a diagram illustrating an embodiment 500 showing multiple capabilities of a MAC core. The MAC includes the capability to map user priorities to access categories. The MAC also includes capability to assign one queue to one access category. Each of these access categories includes a corresponding number of attributes including at least one backoff parameter, arbitration inter frame space parameters, transmission opportunities, and/or other access category parameters.

Other capabilities may be included such as those described in accordance with the IEEE 802.11s MAC functionality, including block acknowledgement (ACK), frame aggregation, reverse direction granting, automatic power save delivery (APSD) mode, and/or other parameters.

Other capabilities may also be included such as providing peer to peer linking between different clients and/or communication devices, hybrid automatic repeat request (HARQ) functionality, and/or other parameters.

Moreover, the MAC includes capabilities to allow its implementation and interfacing with different types of physical layer transceivers (PHYs), including a single carrier (SC) type PHY and an orthogonal frequency division multiplexing (OFDM) type PHY. By providing capability to allow implementation with SC type PHYs, a relatively reduced complexity, cheaper communication device may be implemented very quickly using this MAC while that same MAC still includes additional capability for OFDM type PHYs.

It is noted also that the MAC may include an optimization module that allows dynamic adjustment of any of these parameters as directed by a master controller (e.g., a PNC or an AP), by operating conditions, and/or by other means that changes at least one of these parameters in real time (e.g., on the fly). In addition, the backoff parameters can be optimized per flow if the flow is assigned one separate queue. In a finite precision system, this will require a certain number of bits to effectuate optimization of the backoff parameters.

It is noted that many of the application contexts described herein reference piconets (e.g., such as those that are compliant with IEEE 802.15.3c); however, it is also noted that the multi-capability MAC as described herein is also weel suited for WLAN applications (e.g., such as those that are compliant with IEEE 802.11 standards, including the IEEE 802.11 very high throughput (VHT) standards).

Again, when considering the various configurations in which the multi-capability MAC as described herein may be implemented, the polled access period capability is still existent and included within the MAC thereby ensuring its compatibility with those communication devices that employ such functionality. While there may be certain complex means by which such polled access is actually implemented (e.g., various TDMA schemes, etc.), the polled access period capability is implemented within the MAC to ensure forward compatibility with advanced devices. In addition, this also provides for backward compatibility with those devices that operate in accordance with polled access.

As can be seen, low and high efficiency modes (e.g., when comparing the left and right hand side configurations of the FIG. 4) can be implemented using a single MAC core that may be implemented within a communication device that either a SC type PHY or an OFDM type PHY (i.e., it is compatible with and can be implemented with either type of PHY). This provides a great deal of flexibility to different designers and manufacturer seeking to penetrate different and diverse markets.

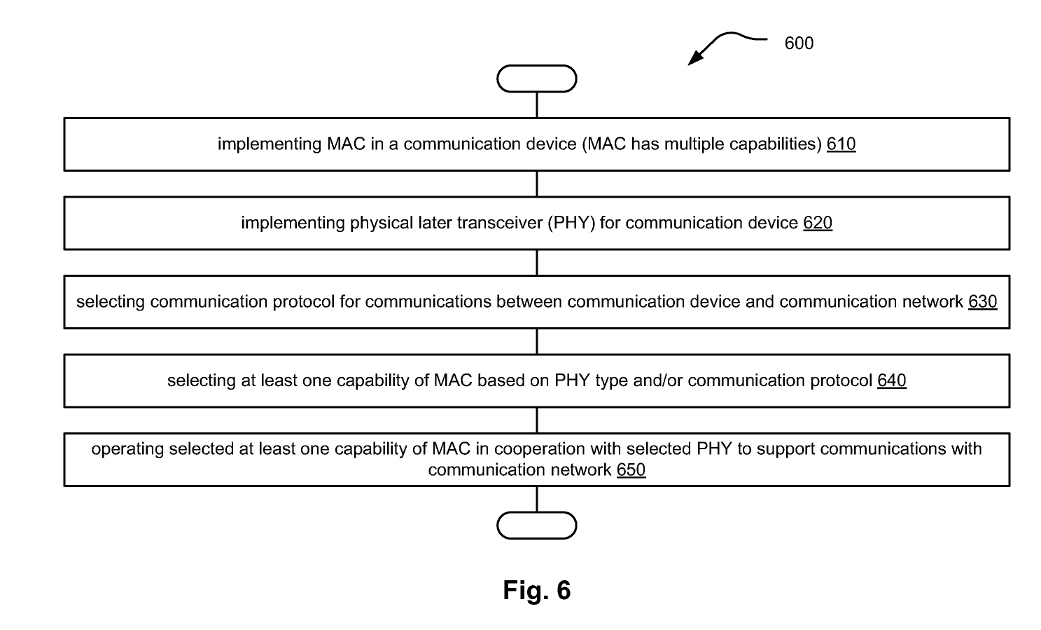

FIG. 6 is a diagram illustrating an embodiment of a method 600 for configuring a communication device. The method 600 begins by implementing MAC in a communication device (MAC has multiple capabilities), as shown in a block 610. The method 600 continues by implementing physical later transceiver (PHY) for communication device, as shown in a block 620.

As can be seen in block 630, the method 600 operates by selecting communication protocol for communications between communication device and communication network. The method 600 continues by selecting at least one capability of MAC based on PHY type and/or communication protocol, as shown in a block 640.

The method 600 continues by operating selected at least one capability of MAC in cooperation with selected PHY to support communications with communication network, as shown in a block 650.

It is noted that the various modules (e.g., encoding modules, decoding modules, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus, comprising:
a medium access controller (MAC) that is operative in accordance each of a plurality of capabilities, one of the plurality of capabilities being selectable for use in the apparatus; and wherein:
when the MAC is implemented within the apparatus, one of the plurality of capabilities of the MAC is enabled based on each of:
a type of physical layer transceiver (PHY) with which the MAC interfaces; and
a communication protocol by which the apparatus communicates with a communication network; and wherein:
each of the plurality of capabilities of the MAC has a respective plurality of operational parameters by which the MAC can operate;
the communication protocol employs carrier sense multiple access/collision avoidance (CSMA/CA) functionality adapted to arbitrate between a first request made by the apparatus to access the communication network and a second request made by at least one additional apparatus to access the communication network; and
the MAC includes an optimization module that is operative to adjust at least one operational parameter based on a change of an operational condition of the communication network.

2. The apparatus of claim 1, wherein:
the MAC is operative in accordance with a first plurality of operational parameters when a first capability of the plurality of capabilities of the MAC is enabled; and
the MAC is operative in accordance with a second plurality of operational parameters when a second capability of the plurality of capabilities of the MAC is enabled.

3. The apparatus of claim 1, wherein:
a first plurality of operational parameters includes an operational parameter; and
a second plurality of operational parameters also includes the operational parameter.

4. The apparatus of claim 1, wherein:
at least one of the plurality of capabilities includes a prioritization capability to map a plurality of user priorities to a plurality of access categories.

5. The apparatus of claim 1, wherein:
the communication protocol is a first communication protocol;
the apparatus is operative to receive a superframe that includes a contention access period (CAP) and a plurality of channel time allocation (CTA) periods;
during the CAP, the communication protocol is operative to employ the CSMA/CA functionality adapted to arbitrate between the first request made by the apparatus to access the communication network and the second request made by at least one additional apparatus to access the communication network; and
during the plurality of CTA periods, the communication protocol is operative to employ polled access thereby allowing the apparatus to access the communication network at a first time and the at least one apparatus to access the communication network at a second time.

6. The apparatus of claim 1, wherein the communication protocol supports at least one of:
block acknowledgement;
frame aggregation;
reverse direction grant;
automatic power saving delivery (APSD) functionality;
direct peer to peer linking between the apparatus and at least one additional apparatus; and
hybrid automatic repeat request (HARQ) functionality.

7. The apparatus of claim 1, wherein:
the apparatus is a communication device that includes the MAC and one PHY;
the MAC interfaces with the one PHY; and
the one PHY is a single carrier type PHY.

8. The apparatus of claim 1, wherein:
the apparatus is a communication device that includes the MAC and one PHY;
the MAC interfaces with the one PHY; and
the one PHY is an orthogonal frequency division multiplexing (OFDM) type PHY.

9. The apparatus of claim 1, wherein:
the apparatus is a wireless communication device; and
the wireless communication device is a transceiver.

10. An apparatus, comprising:
a medium access controller (MAC) that is operative in accordance each of a plurality of capabilities, one of the plurality of capabilities being selectable for use in the apparatus; and wherein:
when the MAC is implemented within the apparatus, one of the plurality of capabilities of the MAC is enabled based on at least one of:
a type of physical layer transceiver (PHY) with which the MAC interfaces; and
a communication protocol by which the apparatus communicates with a communication network; and wherein:
each of the plurality of capabilities of the MAC has a respective plurality of operational parameters by which the MAC can operate.

11. The apparatus of claim 10, wherein:
the communication protocol employs carrier sense multiple access/collision avoidance (CSMA/CA) functionality adapted to arbitrate between competing requests by the apparatus and at least one additional apparatus to access the communication network.

12. The apparatus of claim 10, wherein:
one of the plurality of capabilities includes a prioritization capability to map a plurality of user priorities to a plurality of access categories.

13. The apparatus of claim 10, wherein the MAC further comprises:
an optimization module that is operative to adjust at least one operational parameter based on a change of an operational condition of the communication network.

14. The apparatus of claim 10, wherein:
the communication protocol is a first communication protocol;
the apparatus receives a superframe that includes a contention access period (CAP) and a plurality of channel time allocation (CTA) periods;
during the CAP, the communication protocol employs carrier sense multiple access/collision avoidance (CSMA/CA) functionality adapted to arbitrate between competing requests by the apparatus and at least one additional apparatus to access the communication network; and
during the plurality of CTA periods, the communication protocol employs polled access thereby allowing the apparatus to access the communication network at a first time and the at least one apparatus to access the communication network at a second time.

15. The apparatus of claim 10, wherein the communication protocol supports at least one of:
block acknowledgement;
frame aggregation;
reverse direction grant;
automatic power saving delivery (APSD) functionality;
direct peer to peer linking between the apparatus and at least one additional apparatus; and
hybrid automatic repeat request (HARQ) functionality.

16. The apparatus of claim 10, wherein:
the apparatus is a communication device that includes the MAC and one PHY;
the MAC interfaces with the one PHY; and
the one PHY is a single carrier type PHY.

17. The apparatus of claim 10, wherein:
the apparatus is a communication device that includes the MAC and one PHY;
the MAC interfaces with the one PHY; and
the one PHY is an orthogonal frequency division multiplexing (OFDM) type PHY.

18. The apparatus of claim 10, wherein:
the apparatus is a wireless communication device; and
the wireless communication device is a transceiver.

19. An apparatus, comprising:
a physical layer transceiver (PHY); and
a medium access controller (MAC), connected to the PHY, that is operative in accordance each of a plurality of capabilities, one of the plurality of capabilities being selectable for use in the apparatus; and wherein:
when the MAC is implemented within the apparatus, one of the plurality of capabilities of the MAC is enabled based on each of:
a type of the physical layer transceiver (PHY) with which the MAC interfaces; and
a communication protocol by which the apparatus communicates with a communication network; and wherein:
each of the plurality of capabilities of the MAC has a respective plurality of operational parameters by which the MAC can operate;
the communication protocol employs carrier sense multiple access/collision avoidance (CSMA/CA) functionality adapted to arbitrate between a first request made by the apparatus to access the communication network and a second request made by at least one additional apparatus to access the communication network;
the MAC includes an optimization module that is operative to adjust at least one operational parameter based on a change of an operational condition of the communication network;
the MAC is operative in accordance with a first plurality of operational parameters when a first capability of the plurality of capabilities of the MAC is enabled;
the MAC is operative in accordance with a second plurality of operational parameters when a second capability of the plurality of capabilities of the MAC is enabled; and
the PHY is a single carrier type PHY or an orthogonal frequency division multiplexing (OFDM) type PHY.

20. The apparatus of claim 19, wherein:
the communication protocol is a first communication protocol;
the apparatus receives a superframe that includes a contention access period (CAP) and a plurality of channel time allocation (CTA) periods;
during the CAP, the communication protocol employs carrier sense multiple access/collision avoidance (CSMA/CA) functionality adapted to arbitrate between competing requests by the apparatus and at least one additional apparatus to access the communication network; and
during the plurality of CTA periods, the communication protocol employs polled access thereby allowing the apparatus to access the communication network at a first time and the at least one apparatus to access the communication network at a second time.
